(19) United States
(12) Patent Application Publication
(10) Pub. No.: US 2012/0161026 A1
(43) Pub. Date: Jun. 28, 2012

(54) IMAGE CAPTURE CONTROLLER AND RADIOGRAPHIC IMAGE CAPTURE SYSTEM

(75) Inventors: Kouichi KITANO, Kanagawa (JP); Kentaro NOMA, Kanagawa (JP); Yukihisa IKEGAME, Kanagawa (JP)

(73) Assignee: FUJIFILM CORPORATION, Tokyo (JP)

(21) Appl. No.: 13/301,784

(22) Filed: Nov. 22, 2011

(30) Foreign Application Priority Data
Dec. 28, 2010 (JP) 2010-292139

(51) Int. Cl. G01T 1/16

(52) U.S. Cl. 250/394

(57) ABSTRACT

An image capture controller includes: a communication unit that communicates with a portable radiographic image capture device that captures a radiographic image and generates image data indicating the captured radiographic image; a measuring unit that measures a duration of an off state of a power supply when a power supply of the portable radiographic image capture device has been turned off; and a controlling unit that controls the communication unit such that, if the measured duration is equal to or greater than a predetermined value, a calibration is performed in the portable radiographic image capture device when the power supply thereof is changed from off to on, and such that, if the measured duration is less than the predetermined value, the calibration is not performed in the portable radiographic image capture device when the power supply thereof is changed from off to on.

### CROSS-REFERENCE TO RELATED APPLICATION

This application claims priority under 35 USC 119 from Japanese Patent Application No. 2010-292139 filed on Dec. 28, 2010, the disclosure of which is incorporated by reference herein.

### BACKGROUND OF THE INVENTION

1. Field of the Invention

The present invention relates to an image capture controller that controls a portable radiographic image capture device and a radiographic image capture system.

2. Description of the Related Art

In recent years, a radiation detector such as a flat panel detector (FPD) has been put into practical use in which a radiation-sensitive layer is disposed on a thin film transistor (TFT) active matrix substrate and which thus can directly convert radiation into digital data. A portable radiographic image capture device (hereinafter, also referred to as an “electronic cassette”) has been put into practical use which generates by the FPD image information (data) indicating a radiographic image representing applied radiation and which stores the generated image data.

The electronic cassette is generally configured to incorporate a battery (chargeable secondary battery or primary battery) and supply power from the battery to various circuits and elements, to thereby avoid to impair the portability thereof.

In order to control the behavior of such electronic cassette, various technologies have been recently developed. For example, Japanese Patent Application Laid-Open (JP-A) No. 2010-29419 discloses an electronic cassette that clocks an elapsed time after an image capture is performed and determines whether a next image capture can be performed or not.

However, various analog devices provided in the electronic cassette cannot stably operate unless the temperature has been risen to a certain degree. In a case in which a power supply is turned off due to consumption of the battery of the electronic cassette or removal of the battery, if the consumed battery is exchanged with a charged battery immediately or in a predetermined time after the power supply is turned off and then the power supply is turned on, the temperature of the analog devices does not drop and a stable state is maintained. However, if a certain time or more elapses after the power supply is turned off, the temperature of the analog elements drops and the analog elements become unstable. Accordingly, conventionally, when the state of the power supply of the electronic cassette changes from an off state to an on state, because the state of the electronic cassette may be changed depending on the time period (duration) of the off state, calibration (capturing an image without irradiating radiation) is performed each time when the power supply of the electronic cassette changes from the off state to the on state. The image that is captured by the calibration is for a removal of a noise due to dark current of the electronic cassette, or prevention of burning of afterimage due to irradiation of radiation.

However, performing the calibration every time causes a long image capture waiting time every time when the power supply of the electronic cassette changes from the off state to the on state, and is burdensome to a user. JP-A No. 2010-29419 does not disclose or suggest a technology for resolving the above situation.

### SUMMARY

The present invention has been made in view of the above circumferences and is to provide an image capture controller and a radiographic image capture system that can reduce the frequency of generation of a long image capture waiting time and alleviate the burden caused to a user, as compared with the case in which calibration is always performed when the power supply of an electronic cassette (portable radiographic image capture device) changes from an off state to an on state.

A first aspect of the present invention is an image capture controller that includes a communication unit that communicates with a portable radiographic image capture device that captures a radiographic image representing irradiated radiation and generates image data indicating the captured radiographic image; a measuring unit that measures a duration of an off state of a power supply when a power supply of the portable radiographic image capture device has been turned off; and a controlling unit that controls the communication unit such that, if the measured duration is equal to or greater than a predetermined value, a calibration is performed in the portable radiographic image capture device when the power supply thereof is changed from the off state to an on state, and such that, if the measured duration is less than the predetermined value, the calibration is not performed in the portable radiographic image capture device when the power supply thereof is changed from the off state to the on state.

According to the first aspect, a frequency of occurrence of a long image capture waiting time can be reduced and a burden caused to a user can be alleviated, as compared with the case in which the calibration is always performed when the power supply of the portable radiographic image capture device changes from off to on.

In the first aspect, the image capture controller may further include a determining unit that determines whether the power supply of the portable radiographic image capture device is in the off state or the on state, according to a communication state between the portable radiographic image capture device and the communication unit.

Thereby, whether the state of the power supply of the portable radiographic image capture device is on or off can be easily determined.

A second aspect of the present invention is a radiographic image capture system that includes a portable radiographic image capture device that captures a radiographic image representing irradiated radiation and generates image data indicating the captured radiographic image; and the image capture controller according to the first aspect.

According also to the second aspect, the frequency of occurrence of a long image capture waiting time can be reduced and the burden caused to a user can be alleviated, as compared with the case in which the calibration is always performed when the power supply of the portable radiographic image capture device changes from off to on.

In the second aspect, the image capture controller may further include a determining unit that determines whether the power supply of the portable radiographic image capture device is in the off state or the on state, according to a communication state between the portable radiographic image capture device and the communication unit.

In the second aspect, the portable radiographic image capture device may be driven by a battery that is detachable.

As described above, according to the aspects of the present invention, the frequency of occurrence of a long image capture waiting time can be reduced and the burden caused to a user can be alleviated, as compared with the case in which the calibration is always performed when the power supply of the portable radiographic image capture device changes from off to on.

### BRIEF DESCRIPTION OF THE DRAWINGS

An exemplary embodiment of the present invention will be described in detail based on the following figures, wherein:

FIG. 1 is a block diagram illustrating the configuration of a radiographic image capture system according to an exemplary embodiment;

FIG. 2 is a block diagram illustrating the detailed configuration of the radiographic image capture system according to the exemplary embodiment;

FIGS. 3A and 3B are diagrams illustrating how a battery is mounted in an electronic cassette; and

FIG. 4 is a flowchart illustrating the process of a calibration control program that is executed by a CPU of a console.

### DETAILED DESCRIPTION

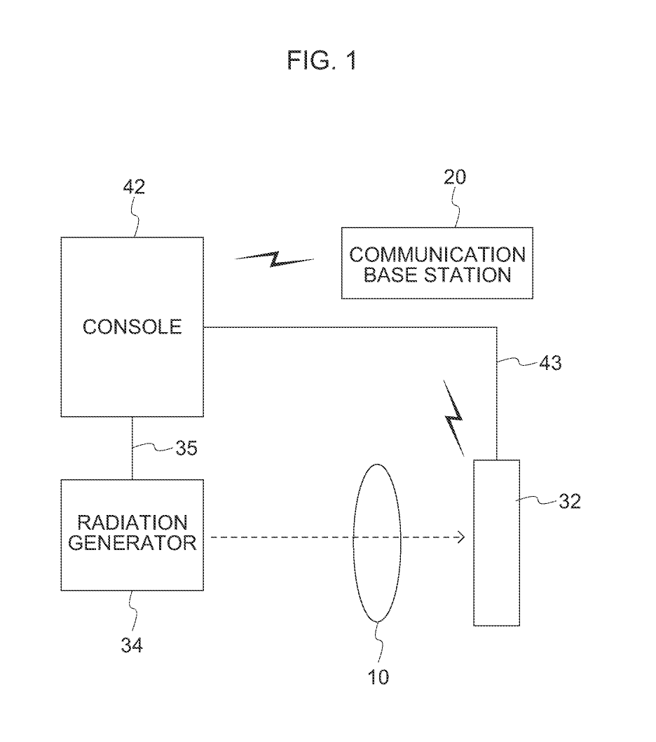

FIG. 1 illustrates an example of the schematic configuration of a radiographic image capture system according to the present exemplary embodiment. The radiographic image capture system that is provided in an image capture room (X-ray room) for capturing a radiographic image (in the present embodiment, X-ray is used as radiation) includes an image capture controller (hereinafter, also referred to as “console”) 42, a radiation generator 34, and a radiographic image capture device (hereinafter, also referred to as “electronic cassette” or “cassette”) 32. A communication base station 20 for performing wireless communication is provided in the X-ray room.

The console 42 is configured to perform wireless communication with the electronic cassette 32 through the communication base station 20. In a state in which the console 42 and the electronic cassette 32 are wire-connected through a cable 43, wired communication can be performed. Accordingly, the console 42 performs communication using either wired communication or wireless communication, and transmits a control signal in order to perform various control operations with respect to the electronic cassette 32. The console 42 is connected to the radiation generator 34 through a cable 35 and controls timings of radiation generation.

The radiation generator 34 irradiates radiation onto a subject 10 at a timing based on the control from the console 42. The radiation that is irradiated from the radiation generator 34 is transmitted through the subject 10 and is irradiated onto the electronic cassette 32. The electronic cassette 32 captures a radiographic image that is represented by the irradiated radiation and generates image information (data) that shows the captured radiographic image. The generated image data is transmitted to the console 42 by wired communication or wireless communication.

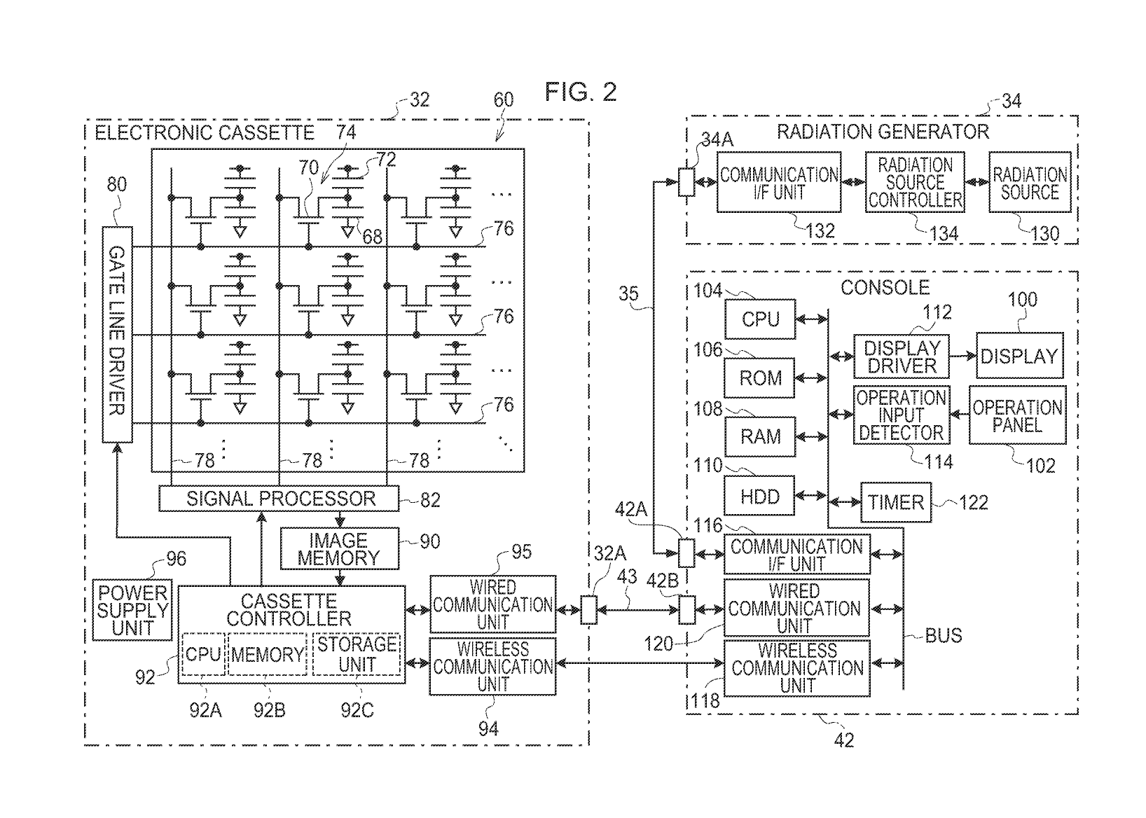

FIG. 2 is a block diagram illustrating the detailed configuration of the radiographic image capture system according to the first embodiment.

The radiation generator 34 includes a connecting terminal 34A for performing communication with the console 42. The console 42 includes a connecting terminal 42A for performing communication with the radiation generator 34 and a connecting terminal 42B for performing communication with the electronic cassette 32.

The radiation generator 34 is connected to the console 42 through the cable 35. The cable 43 is connected to the connecting terminal 32A of the electronic cassette 32 when a radiographic image is captured and the electronic cassette 32 is connected to the console 42 through the cable 43.

The radiation detector 60 that is incorporated in the electronic cassette 32 is configured with a photoelectric conversion layer for absorbing radiation X and converting the radiation into charges that is stacked on a TFT active matrix substrate 66. The photoelectric conversion layer is made of amorphous a-Se (amorphous selenium) containing selenium as a principal component (for example, having content rate of 50% or more). When radiation X is irradiated, the photoelectric conversion layer internally generates charges (pairs of electron and hole) of charge amount according to the irradiated radiation dose and converts the irradiated radiation X into the charges. The radiation detector 60 may indirectly convert the irradiated radiation X into charges using a phosphor material and a photoelectric conversion element (photodiode), instead of a radiation-charge conversion material such as the amorphous selenium that directly converts radiation X into charges. As the phosphor material, gadolinium oxysulfide (GOS) or cesium iodide (CsI) can be used. In this case, radiation X is converted into light by the phosphor material and the light is converted into charges by the photodiode of the photoelectric conversion element.

On the TFT active matrix substrate 66, plural pixels 74 (in FIG. 2, the photoelectric conversion layer corresponding to each pixel 74 is schematically illustrated as a photoelectric conversion unit 72) each of which includes a storage capacitor 68 that accumulates charges generated by the photoelectric conversion layer and a TFT 70 that reads the charges accumulated in the storage capacitor 68 are arranged in a matrix. The charges that are generated in the photoelectric conversion layer due to irradiation of radiation X onto the electronic cassette 32 are accumulated in the storage capacitor 68 of each of the pixels 74. Thereby, image information that has been carried in the radiation X irradiated onto the electronic cassette 32 is converted into charge information and is held in the radiation detector 60.

The TFT active matrix substrate 66 includes plural gate lines 76 that extend in one direction (row direction) and are used to turn on/off the TFT 70 of each pixel 74, and plural data lines 78 that extend in a direction (column direction) substantially orthogonal to the gate lines 76 and are used to read the accumulated charges from the storage capacitor 68 through a TFT 70 which has been turned on. Each gate line 76 is connected to a gate line driver 80 and each data line 78 is connected to a signal processor 82. When charges are accumulated in the storage capacitor 68 of each pixel 74, the TFT 70 of each pixel 74 is sequentially turned on in a row unit by a signal supplied from the gate line driver 80 through the gate line 76. The charges that are accumulated in the storage capacitor 68 of the pixel 74 where the TFT 70 is turned on is transmitted as an analog electric signal through the data line 78 and is input to the signal processor 82. Accordingly, the charges that are accumulated in the storage capacitor 68 of each pixel 74 is sequentially read in a row unit.

Although not illustrated in the drawings, the signal processor 82 includes an amplifier and a sampling/holding circuit that are provided for each data line 78. The charge signal that is transmitted through each data line 78 is amplified by the amplifier and is held in the sampling/holding circuit. A multiplexer and an analog/digital (A/D) converter are sequentially connected to the output end of the sampling/holding circuit, and the charge signal that is held in each sampling/holding circuit is sequentially (serially) input to the multiplexer and is converted into digital image data by the A/D converter.

An image memory 90 is connected to the signal processor 82 and the image data that is output from the A/D converter of the signal processor 82 is sequentially stored in the image memory 90. The image memory 90 has a storage capacity that can store image data indicating a predetermined number of frames' worth of radiographic images, and each time the charges are read line by line, image data corresponding to each read line is sequentially stored in the image memory 90

The image memory 90 is connected to a cassette controller 92 that controls the entire operation of the electronic cassette 32. The cassette controller 92 is realized by a microcomputer and includes a CPU 92A, memory 92B including ROM and RAM, and a non-volatile storage unit 92C including an HDD or flash memory.

A wireless communication unit 94 and a wired communication unit 95 are connected to the cassette controller 92. The wireless communication unit 94 complies with a wireless local area network (LAN) standard that typically includes the Institute of Electrical and Electronics Engineers (IEEE) 802.11a/b/g, and controls transmission of various data between external devices and the wireless communication unit 94 with the wireless communication. The wired communication unit 95 is connected to the connecting terminal 32A, and controls transmission of various data between the console 42 and the wired communication unit 95 through the connecting terminal 32A and the cable 43. The cassette controller 92 performs transmission and reception of various data between the console 42 and the cassette controller 92 through the wireless communication unit 94 or the wired communication unit 95.

A power supply unit 96 is provided in the electronic cassette 32 and various circuits or elements (the detection unit 33, the gate line driver 80, the signal processor 82, the image memory 90, the wireless communication unit 94, the wired communication unit 95, and the microcomputer functioning as the cassette controller 92) described above operates by power supplied from the power supply unit 96. The power supply unit 96 is charged by power that is supplied through the cable 43 when the cable 43 is connected to the connecting terminal 32A. The power supply unit 96 incorporates a battery 96A (chargeable secondary battery) so that the portability of the electronic cassette 32 is not deteriorated and supplies power from the charged battery 96A to the various circuits and elements. Although a secondary battery is used as the battery 96A in the present embodiment, embodiments are not limited thereto and the battery may be a primary battery. In FIG. 2, wirings that connect the power supply unit 96 and the various circuits or elements are not illustrated.

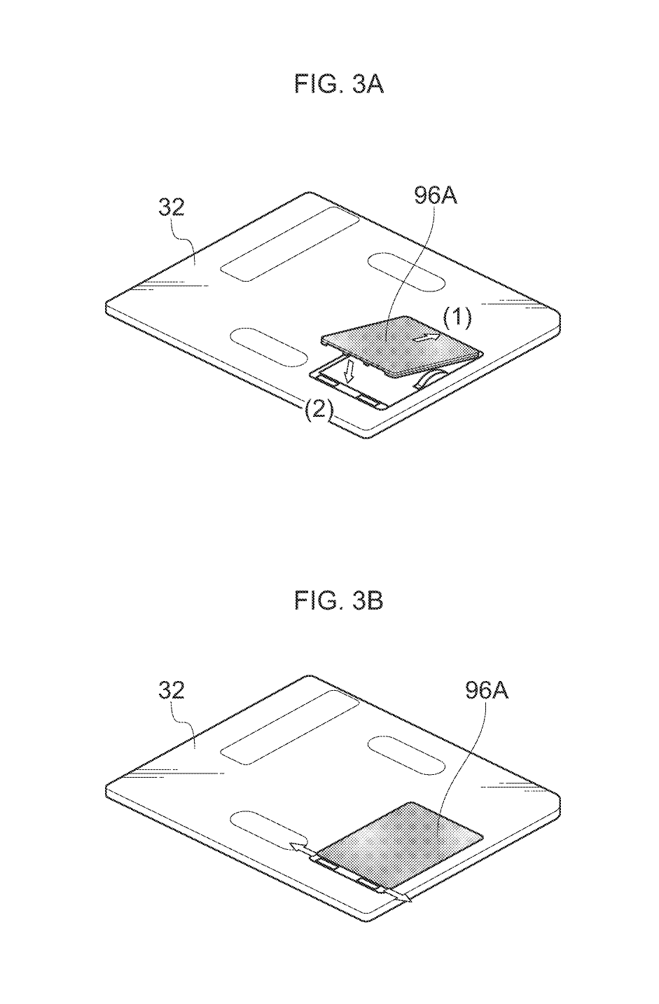

As illustrated in FIGS. 3A and 3B, the battery 96A is detachable with respect to the electronic cassette 32. As illustrated in FIG. 3A, by contacting one side of the battery 96A which is a card type battery with one side of a concave portion of the electronic cassette 32 (step (1) in FIG. 3A) and then fitting the opposite side to the one side into another side of the concave portion (step (2) in FIG. 3A), the entire battery 96A is fitted into the concave portion of the electronic cassette 32. In a state in which the battery 96A is fitted into the concave portion, the battery 96A is mounted in the electronic cassette 32 by locking the battery 96A to prevent the battery 96A being easily separated from the electronic cassette 32 (refer to FIG. 3B). The battery 96A can be detached from the electronic cassette 32 by performing a reverse operation of the above operation. The shape of the battery 96A or the attaching/detaching method thereof the battery 96A explained above is an example and embodiments are not limited thereto.

While the battery 96A that has been charged and can drive the electronic cassette 32 is mounted in the electronic cassette 32, a power supply state of the electronic cassette 32 is maintained in an on state. However, when the battery 96A is detached from the electronic cassette 32 or the battery 96A is consumed and is run out (the remaining charge amount of the battery becomes less than an amount that the battery can drive the electronic cassette 32), the power supply state of the electronic cassette 32 changes to an off state.

The console 42 is configured as a server computer and includes a display 100 that displays an operation menu or a captured radiographic image, and an operation panel 102 that is configured to include plural keys and receives various data or operation instructions.

The console 42 according to the present embodiment includes a CPU 104 that manages the entire operation of the device, a ROM 106 in which various programs including a control program are stored in advance, a RAM 108 that temporarily stores various data, an HDD 110 that stores and holds the various data, a display driver 112 that controls display of the various data with respect to the display 100, an operation input detector 114 that detects an operation state with respect to the operation panel 102, a communication interface (I/F) unit 116 that is connected to the connecting terminal 42A and transmits and receives various data such as exposure conditions (described later) between the radiation generator 34 and the communication I/F unit 116 through the connecting terminal 42A and the cable 35, a wireless communication unit 118 that transmits and receives various data between the electronic cassette 32 and the wireless communication unit 118 by wireless communication, a wired communication unit 120 that is connected to the connecting terminal 42B and transmits and receives various data between the electronic cassette 32 and the wired communication unit 120 through the connecting terminal 42B and the cable 43, and a timer 122.

The CPU 104, the ROM 106, the RAM 108, the HDD 110, the display driver 112, the operation input detector 114, the communication I/F unit 116, the wireless communication unit 118, and the wired communication unit 120 are all connected to each other through a system bus BUS. Therefore, the CPU 104 can access to the ROM 106, the RAM 108, and the HDD 110, and can perform control of displaying various data with respect to the display 100 through the display driver 112, control of transmission/reception of various data with the radiation generator 34 through the communication I/F unit 116, control of transmission/reception of various data with the electronic cassette 32 through the wireless communication unit 118, and control of transmission/reception of various data with the electronic cassette 32 through the wired communication unit 120. The CPU 104 can grasp an operation state of a user with respect to the operation panel 102 through the operation input detector 114. The timer 122 is a timer (in the present embodiment, count-up counter) that measures duration of the off state of the power supply in the electronic cassette 32.

The radiation generator 34 includes a radiation source 130 that outputs radiation X, a communication I/F unit 132 that transmits and receives various data such as the exposure conditions between the console 42 and the communication I/F unit 132, and a radiation source controller 134 that controls the radiation source 130 based on the received exposure conditions.

The radiation source controller 134 is also realized by a microcomputer and stores the received exposure conditions. The exposure conditions received from the console 42 include a set of data including a tube voltage, a tube current, and an exposure period. The radiation source controller 134 irradiates radiation X from the radiation source 130 based on the received exposure conditions.

Next, an operation of the radiographic image capture system according to the present embodiment will be described.

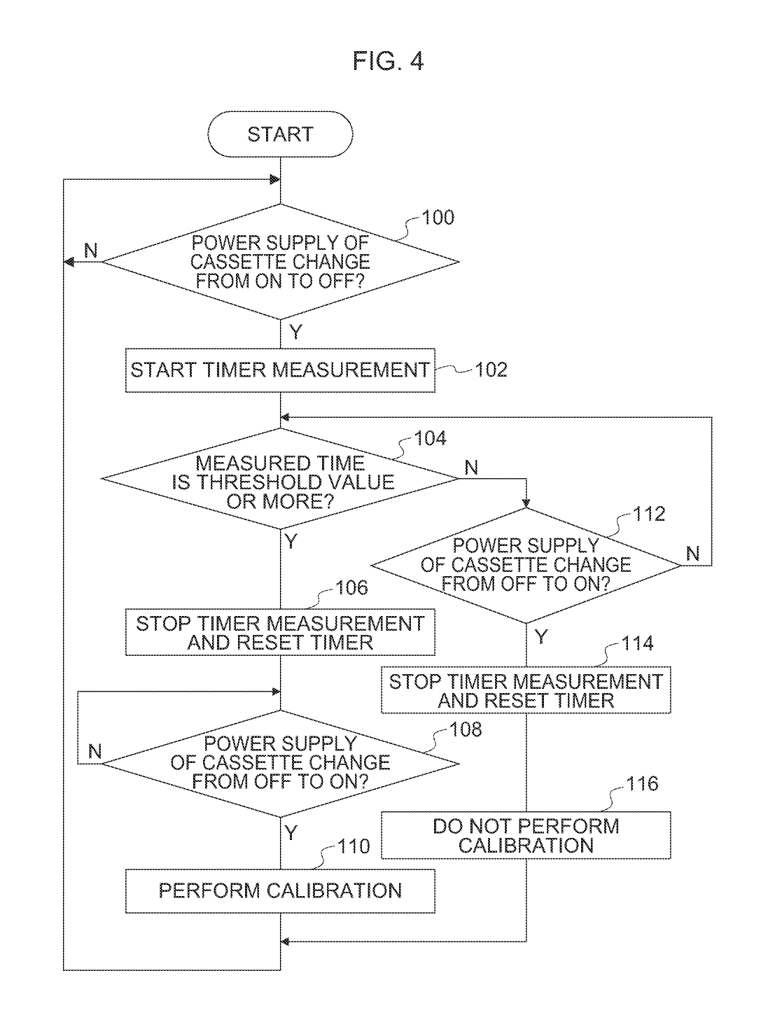

FIG. 4 is a flowchart illustrating the processing of a calibration control program that is executed by the CPU 104 of the console 42. The calibration control program is stored in advance in a predetermined area of the memory 106 (ROM) or the HDD 110.

In step 100, the console 42 determines whether the power supply state of the electronic cassette 32 is changed from on to off. In the present embodiment, the console 42 also executes processing for checking a communication state with the electronic cassette 32 in parallel to the calibration control program, which is not illustrated in the drawings. Specifically, the console 42 tries wired communication and wireless communication with respect to the electronic cassette 32 at predetermined time interval, and determines whether the power supply of the electronic cassette 32 is turned on or off according to whether or not a response has been returned from the electronic cassette 32. If at least one of wired or wireless communication is possible between the electronic cassette 32 and the console 42, the console 42 determines that the power supply of the electronic cassette 32 is turned on. If both wired and wireless communications are impossible, the console 42 determines that the power supply of the electronic cassette 32 is turned off. Therefore, in step 100, if a state in which at least one of wired or wireless communication is possible between the electronic cassette 32 and the console 42 changes to a state in which both wired and wireless communications are impossible, the console 42 determines that the power supply of the electronic cassette 32 is changed from on to off.

If the determination result is affirmative (yes) in step 100, the console 42 starts the clocking of the timer 122 in step 102.

In step 104, the console 42 determines whether or not the clocked time of the timer 122 has reached a threshold value or more. The threshold value is set in advance. For example, an amount of time after the power supply state of the electronic cassette 32 has been changed to the off state, the temperature of the analog devices provided in the electronic cassette 32 decreases, and until the operation of the electronic cassette 32 becomes unstable is calculated in advance by testing, and the calculated time can be set as the threshold value.

When the determination result is affirmative in step 104, which means that the duration of the off state of the power supply in the electronic cassette 32 has reached the threshold value or more, the console 42 stops the clocking of the timer 122 and resets the timer 122 in step 106. Then in step 108, the console 42 determines whether or not the power supply state of the electronic cassette 32 changes from off to on. Specifically, when the state in which both wired and wireless communications are impossible between the electronic cassette 32 and the console 42 changes to a state in which at least one of wired or wireless communication is possible, the console 42 determines that the power supply state of the electronic cassette 32 changes from off to on. If both wired and wireless communications remain impossible, the console 42 determines that the electronic cassette 32 is in the off state.

When the determination result is affirmative in step 108, in step 110, the console 42 transmits a control signal that causes the electronic cassette 32 to perform the calibration by controlling the wired communication unit 120 or the wireless communication unit 118, and then the processing returns to step 100. After the electronic cassette 32 receiving the control signal, the electronic cassette 32 performs the calibration according to the control signal.

Here, the calibration unit a process of capturing an image by the electronic cassette 32 without irradiating radiation from the radiation generator 34. The set of image data indicates the captured images (normally plural images are captured) is transmitted to the console 42 and is used for removal of a noise due to dark current of the electronic cassette 32 or prevention of burning of afterimage due to irradiation of radiation.

If the determination result is negative (no) in step 104, the processing proceeds to step 112, in which, similarly to step 108, the console 42 determines whether the power supply state of the electronic cassette 32 is changed from off to on. If the determination result is negative in step 112, the processing returns to step 104. If the determination result is affirmative in step 112, which means that the duration of the off state of the power supply of the electronic cassette 32 is less than threshold value, the processing proceeds to step 114 and the console 42 stops the clocking of the timer 122 and resets the timer 122. In step 116, the console 42 transmits a control signal for preventing execution of the calibration to the electronic cassette 32 by controlling the wired communication unit 120 or the wireless communication unit 118, and then the processing returns to step 100. The electronic cassette 32 which has received the control signal does not perform the calibration.

That is, when the duration of the off state of the power supply of the electronic cassette 32 is less than the threshold value, since the temperature of the analog devices of the electronic cassette 32 does not drop significantly, a stable state is maintained. Therefore, there is no need to perform the calibration when the power supply state of the electronic cassette 32 changes from off to on in this case, and the console 42 performs control of preventing the calibration being performed in the electronic cassette 32.

In this case, the console 42 performs the control of preventing the calibration being performed in the electronic cassette 32 by transmitting the control signal to prevent execution of the calibration to the electronic cassette 32. However, the console 42 may perform such control by inhibiting transmission of the control signal to cause the electronic cassette 32 to perform the calibration.

As described above, the console 42 is configured such that when the power supply state of the electronic cassette 32 becomes off, the console 42 measures the duration of the off state of the power supply, if the measured duration reaches the threshold value or more, causes the electronic cassette 32 to perform the calibration when the power supply state of the electronic cassette 32 is changed from off to on, and if the measured duration is less than the threshold value, prevents the electronic cassette 32 from performing the calibration when the power supply state of the electronic cassette 32 is changed from off to on. Therefore, the frequency of occurrence of a long image capture waiting time can be reduced and a burden on the user caused thereby can be alleviated, as compared with the case in which the calibration is always performed when the power supply state of the electronic cassette 32 is changed from off to on.

In the present embodiment, the wired communication unit and the wireless communication unit are provided in both the console 42 and the electronic cassette 32, and the communication is enabled in both wired communication and wireless communication. However, embodiments are not limited thereto. For example, only the wireless communication may be enabled. In this case, in the above-described embodiment, a determination may be made, in steps 100, 108 and 112, as to whether the power supply state of the electronic cassette 32 is in the on state or the off state according to whether the wireless communication is possible or not between the console 42 and the electronic cassette 32.

In the present embodiment, a count-up time is employed as the timer 122 and the clocking of the timer 122 is stopped when the time clocked by the timer 122 has reached the threshold value or more. However, embodiments are not limited thereto. For example, the clocking of the timer 122 may be stopped when the power supply state of the electronic cassette 32 changes to the on state after the clocked time has reached the threshold value or more. Alternatively, a counting-down timer may be employed for the timer 122, and the clocking of the timer 122 may be automatically stopped when the clocked time reaches the threshold value.

In the present embodiment, the console 42 and the radiation generator 34 are provided as separate devices. However, embodiments are not limited thereto. For example, the console 42 and the radiation generator 34 may be configured as one device.

In the present embodiment, a case in which one electronic cassette 32 is used in the radiographic image capture system is described. However, embodiments are not limited thereto, and even in a case in which plural electronic cassettes 32 are provided in the radiographic image capture system, the calibration can be controlled for each electronic cassette 32 in a similar manner as described above in the present embodiment.

In the present embodiment, X-ray is applied as radiation. However, embodiments are not limited thereto and gamma rays may be applied as radiation.

Further, the electronic cassette 32 may be configured such that the power supply can be turned off even if the battery 96A is mounted by providing a power switch in the electronic cassette 32. Even in this case, a similar control operation can be performed by determining whether the power supply state is on or off based on the communication state, as described above.

The configuration of the radiographic image capture system (FIGS. 1 and 2) described in the embodiment and the shape and the attaching/detaching method (FIGS. 3A and 3B) of the battery are examples, and can be changed depending on applications in a range without departing from the gist of the invention.

Further, the processes (FIG. 4) of the programs that are described in the present embodiment are examples and can be changed depending on applications in a range without departing from the gist of the invention.

What is claimed is:

1. An image capture controller comprising:
a communication unit that communicates with a portable radiographic image capture device that captures a radiographic image representing irradiated radiation and generates image data indicating the captured radiographic image;
a measuring unit that measures a duration of an off state of a power supply when a power supply of the portable radiographic image capture device has been turned off; and
a controlling unit that controls the communication unit such that, if the measured duration is equal to or greater than a predetermined value, a calibration is performed in the portable radiographic image capture device when the power supply thereof is changed from the off state to an on state, and such that, if the measured duration is less than the predetermined value, the calibration is not performed in the portable radiographic image capture device when the power supply thereof is changed from the off state to the on state.

2. The image capture controller according to claim 1, further comprising:
a determining unit that determines whether the power supply of the portable radiographic image capture device is in the off state or the on state, according to a communication state between the portable radiographic image capture device and the communication unit.

3. A radiographic image capture system comprising:
a portable radiographic image capture device that captures a radiographic image representing irradiated radiation and generates image data indicating the captured radiographic image; and
the image capture controller according to claim 1.

4. The radiographic image capture system according to claim 3, wherein the image capture controller further comprises a determining unit that determines whether the power supply of the portable radiographic image capture device is in the off state or the on state, according to a communication state between the portable radiographic image capture device and the communication unit.

5. The radiographic image capture system according to claim 3, wherein the portable radiographic image capture device is driven by a battery that is detachable.
